(19) United States
(12) Patent Application Publication
(10) Pub. No.: US 2010/0331017 A1
(43) Pub. Date: Dec. 30, 2010

(54) METHOD AND SYSTEM OF EFFICIENTLY USING MOBILE TERMINAL CONTEXT

(75) Inventor: Kenichi Ariga, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/867,982

(22) PCT Filed: Feb. 20, 2009
(86) PCT No.: PCT/JP2009/052978

§ 371 Date: Aug. 17, 2010

(30) Foreign Application Priority Data
Feb. 21, 2008 (JP) 2008-040333

(51) Int. Cl. H04W 4/02

(52) U.S. Cl. 455/456.3

(57) ABSTRACT

A system includes a context manager that stores, as a device catalog in a storage unit, attribute information and execution condition of a device from which an application acquires context information to execute a predetermined function and that selects a device which the application uses responsive to a request from the application. The application sends a collection policy of the context information relating a device which the application uses to the context manager. The context manager selects a device complying with the collection policy based on the collection policy from the application side and the attribute information and execution condition of the device stored in the device catalog. Upon receiving a context collection request from the application, the context manager provides the application with the context information collected by the selected device.

### TECHNICAL FIELD

### Reference to Related Application

This application is based upon and claims the benefit of the priority of Japanese patent application No. 2008-040333, filed on Feb. 21, 2008, the disclosure of which is incorporated herein in its entirety by reference thereto.

The present invention relates to an information processing technique applicable to mobile terminals and the like, and in particular, to a system, a method, and a terminal capable of using a more appropriate device among a plurality of devices.

### BACKGROUND

Recently, mobile terminals include devices capable of acquiring various kinds of context information relating to a GPS (Global Positioning System), a base station ID, a direction sensor, and the like. Alternatively, by inserting such devices into a card slot, mobile terminals function in the same way.

However, since an application installed in a terminal or in a server connected to a network specifies a device acquiring a context and controls the acquisition control, it is unclear if an optimum device is used and a context is acquired under optimum conditions. For example, when an application needs location information with an accuracy of 2 kilometer range, there are cases in which a terminal uses a GPS and acquires location with an accuracy of approximately 10 meter range. Even if the terminal can acquire a more appropriate context complying with conditions set by the application by using a base station ID, the terminal may use a GPS. In this case, the power consumption of the terminal may be increased and a time period during which a user can operate the terminal may be affected.

As a related technique for automatically selecting a location determination device that can be used in a mobile terminal, for example, Patent Document 1 discloses a method for generating position information in a mobile equipment provided with at least two position determination devices. The method comprises: allocating a value of at least one parameter to each position determination device and storing the parameter; determining context information; selecting a selection process of a corresponding position determination device based on the context information and the value of at least one parameter allocated to each position determination device; selecting a position determination device in accordance with the selected selection process; and activating the selected position determination device. The parameter value allocated to each position determination device indicates at least one of an accuracy value, a response time value, and a power consumption value. As will be described later, Patent Document 1 is quite different from the present invention in which a device is selected based on a context collection policy sent from an application.

Patent Document 1: Japanese Patent Kohyo Publication No. JP2005-530427 A

### SUMMARY

The entire disclosure of the above Patent Document 1 is incorporated herein by reference thereto. Analysis will be hereinafter made based on the present invention.

When an application uses a context that can be acquired in a terminal and operates, for example, the following problems exist.

First, the application needs to specify a device that acquires a context. Namely, a terminal does not include a function of automatically selecting a device in correspondence with an application.

Additionally, since an application specifies a device that acquires a context, there is no guarantee that a context acquisition method executed by the application is an optimum method that does not place load on the terminal.

Accordingly, it is an object of the present invention to provide a system, a method, and a terminal capable of selecting a more appropriate device under a more appropriate condition according to a request condition set by an application.

To solve the above problems, the invention disclosed in the present application generally has the following configuration.

According to an aspect of the present invention, there is provided an information processing system comprising:

at least one application that acquires context information from a device and executes a predetermined function;

a storage unit that stores attribute information and execution condition of a device as a device catalog; and

a management unit that responsive to a request from the application, selects a device which the application uses. In collecting context information, the application sends a collection policy of the context information to the management unit. Upon receiving the collection policy from the application, the management unit refers to the collection policy from the application and the attribute information and execution condition of a device stored as the device catalog in the storage unit to select a device complying with the collection policy.

According to the present invention, when receiving a context collection request from the application, the management unit supplies context information collected by the selected device to the application.

According to the present invention, the management unit comprises:

a context attribute confirmation unit that analyses contents of attribute information of a context based on a collection policy requested from the application;

an active condition confirmation unit that refers to the device catalog and selects one or more device candidates complying with the attribute information confirmed by the context attribute confirmation unit;

a terminal impact evaluation unit that refers to the device catalog and evaluates a device candidate which gives a minimum terminal impact from among the device candidates selected by the active condition confirmation unit; and

a context collection method determination unit that determines a device necessary for collecting a context, based on a device condition of the candidate selected by the terminal impact evaluation unit.

According to the present invention, the information processing system further comprises a context collection unit that controls a device based on the device and a collection condition determined by the management means.

According to the present invention, the device catalog may comprise, for each device, attribute information including context identification information, a granularity, and a real-time property; and execution condition including an active condition, an impact to a terminal in case of adding a device to the terminal, and a current status.

According to the present invention, a terminal (mobile communication terminal) comprising the information processing system is provided. According to the present invention, the application is operated on the terminal.

According to the present invention, a server system connected to the terminal is provided, and the application is operated on the server system.

According to another aspect of the present invention, there is provided a context utilization method comprising

storing and managing, on a manager side, as a device catalog, attribute information and execution condition of a device from which an application acquires context information to execute a predetermined function and that selects a device which the application uses responsive to a request from the application;

in collecting context information, the application sending a collection policy of the context information to the manager; and

the manager selecting a device complying with the collection policy, based on the collection policy from the application and the attribute information and execution condition of the device stored in the device catalog.

According to the present invention, upon receiving a context collection request from the application, the manager provides the application with context information collected by the selected device. According to the present invention, in collecting the context information, the application sends a context collection request including the collection policy to the management unit, and the management unit selects a device complying with the collection policy so that the application does not need to specify any device.

According to the present invention, in case when an application is acquiring context information from a device, the management unit receives a context information collection request from another application and a conflict for the device occurs between the applications, the management unit performs arbitration of the conflict for the device between the applications, in accordance with priorities of the applications and allows one of the applications having a relatively higher priority to collect context information from the device. According to the present invention, the management unit may select an alternative device for another application having a relatively lower priority.

According to another aspect of the present invention, there is provided a program causing a computer that stores, as a data table (hereinafter referred to as device catalog) in a storage unit, attribute information and execution condition of a device from which an application acquires context information to execute a predetermined function and that selects a device which the application uses responsive to a request from the application to execute:

a processing that when a collection policy relating to the collection of context information is received, selects a device complying with the collection policy, based on the collection policy, and the attribute information and execution condition of the device stored in the device catalog.

According to the present invention, the program causes the computer to provide, upon receiving a context collection request from the application, the application with context information collected by the selected device.

According to the present invention, the program causes the computer to execute: a context attribute confirmation processing that analyzes contents of attribute information about a context based on a collection policy requested from the application; an active condition confirmation processing that refers to the device catalog and selects device candidates complying with the attribute information confirmed by the context attribute identification processing; a terminal impact evaluation processing that refers to the device catalog and selects a device candidate which gives a minimum terminal impact from among the device candidates selected by the active condition confirmation processing; and a context collection method determination processing that determines a device necessary for collecting a context based on a condition of the device candidate selected by the terminal impact evaluation processing. According to the present invention, there is provided a computer-readable recording medium storing the program according to the present invention.

According to the present invention, there is provided a terminal comprising a plurality of devices; and a management unit that stores and manages attribute information and execution condition of the plurality of devices as a device catalog. When an application that operates on the terminal or on a server connected to the terminal collects context information from the device, the application sends a collection policy of the context information to the management unit. The management unit selects a device that complies with the collection policy based on the collection policy requested from the application and the attribute information and the execution condition of the device stored in the device catalog. The application acquires context information from the device selected by the management unit and executes a predetermined function.

According to the present invention, according to a request condition set by an application, a more appropriate device can be selected under a more appropriate condition.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating a configuration according to one mode of the present invention.

FIG. 2 is a diagram illustrating a configuration of a first exemplary embodiment of the present invention.

FIG. 3 illustrates a configuration example of a device catalog in the first exemplary embodiment of the present invention.

FIG. 4 is a flow chart illustrating an operation of the first exemplary embodiment of the present invention.

FIG. 5 is a flow chart illustrating another operation of the first exemplary embodiment of the present invention.

FIG. 6 is a diagram illustrating a configuration of the second exemplary embodiment of the present invention.

FIG. 7 is a diagram illustrating an example to which the second exemplary embodiment of the present invention is applicable.

### PREFERRED MODES

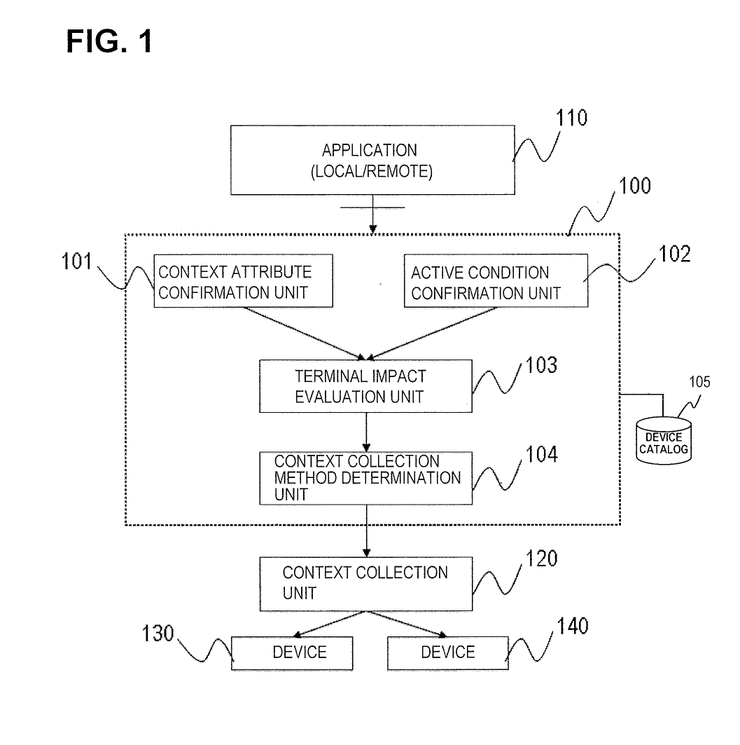

A terminal or a system according one of preferred modes to the present invention includes: a plurality of devices each capable of acquiring context information; and a function of selecting an optimum device based on a condition set by an application. A mode of the present invention will be hereinafter described. FIG. 1 illustrates a configuration according to an exemplary embodiment of the present invention. Referring to FIG. 1, the system according to the exemplary embodiment includes a module (context manager) 100, an application 110, a context collection unit 120, and devices 130 and 140. The context collection unit 120 acquires context information from the device 130 or 140 determined by a context collection method determination unit 104, and the application 110 acquires the context information from the context collection unit 120 via the module 100. The application 110 may be implemented locally (on a node where the system is mounted) or remotely (on a node different from the node where the system is mounted).

The module (context manager) 100 includes a context attribute confirmation unit 101, an active condition confirmation unit 102, a terminal impact evaluation unit 103, and the context collection method determination unit 104. The module 100 including these units 101 to 104 is referred to as “context manager.” These units 101 to 104 basically operate as follows.

The context attribute confirmation unit 101 analyzes contents of attribute information associated with a context requested by the application 110. As will be described later, the attribute information includes context identification information, a granularity, a real-time property, and the like.

The active condition confirmation unit 102 selects device candidates complying with the attribute information confirmed by the context attribute confirmation unit 101.

The terminal impact evaluation unit 103 evaluates among device candidates selected by the active condition confirmation unit 102, a device that would give a minimum terminal impact to the terminal. In this case, the terminal impact designates a load applied to the terminal, such as an increase of power consumption.

Based on conditions of the device candidate selected by the terminal impact evaluation unit 103, the context collection method determination unit 104 determines a device necessary for collecting the context.

The context collection unit 120 controls a device based on a device and a collection condition determined by the context manager 100.

According to the present exemplary embodiment, it is possible to select a device used for collection of context information, in a manner more close to a condition of the context information which is requested by the application 110. As a result, since the terminal does not operate a useless device therein, the present exemplary embodiment contributes to the saving of the power consumption of the terminal.

According to the present exemplary embodiment, the application 110 can send contents of a context and a collection policy to the context manager 100 by using a dedicated interface.

According to the present exemplary embodiment, the terminal includes devices (sensor devices) 130 and 140 capable of acquiring a context and a data table also referred to as a device catalog storing attribute information and execution condition of the device 130 and 140. Thus, the terminal has a function of collecting a context under an optimum conditions.

While the application 110 sends the collection policy (corresponding to the attribute information) to the context manager 100, specific examples of the collection policy include:

context information to be acquired (location information, direction, temperature, movement speed, direction, and the like);

a granularity of the context information to be acquired (location information: within a few kilometer radius, movement speed: per minute, and the like); and

a real-time property (time interval at which the context information is acquired).

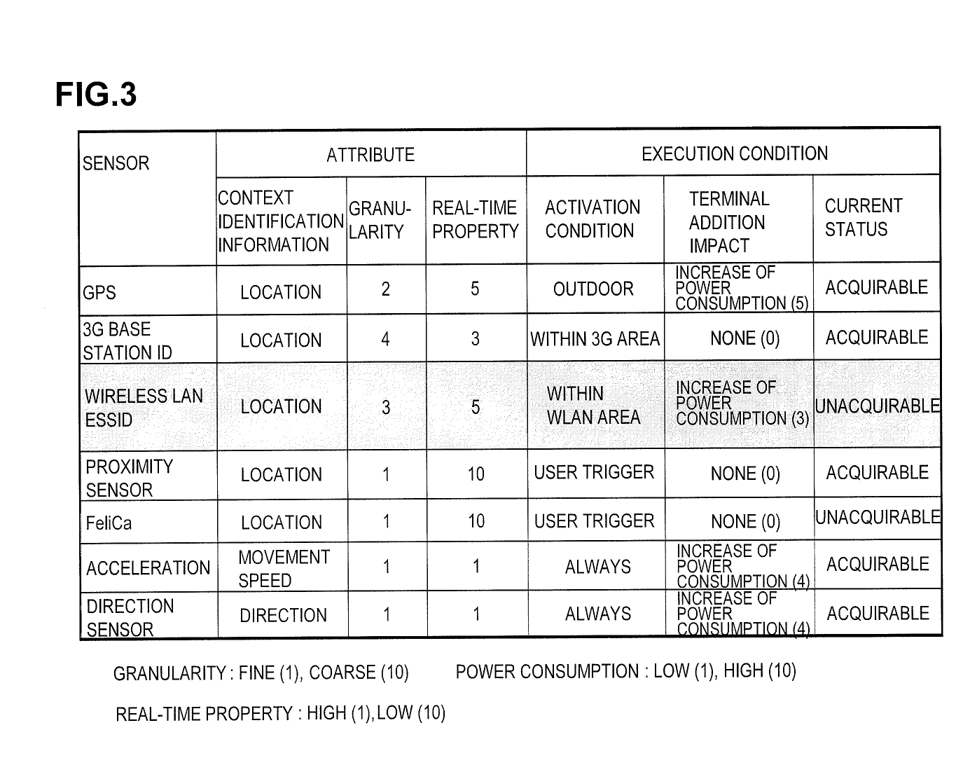

Based on the collection policy requested from the application 110, the context manager 100 refers to the device catalog stored in a storage unit 105, which will be described later in detail with reference to FIG. 3, and determines a device to be used by the application 110 for collecting a context.

The device to be used by the application 110 for collecting a context is determined based on:

the degree of coincidence between the collection policy sent from the application 110 and device attribute information; and an active condition under which a device can be activated.

After device candidates are selected based on the above conditions, a device that would place a minimum additional impact to the terminal, such as an increase of power consumption, is selected. For example, to acquire an ESSID (Extended Service Set identifier of an access point of a wireless local area network (LAN) (IEEE 802.11 for example), devices that can only be activated in wireless LAN areas are selected, and among the selected devices, a device that gives a minimum additional impact to the terminal, such as an increase of power consumption, is selected.

In addition, needless to say, the units 101 to 104 included in the context manager 100 may be realized by computer-executable programs. In the present exemplary embodiment, there is also provided a computer-readable recording medium that stores the above mentioned computer-executable programs. According to the present exemplary embodiment, when the application collects context information, since the context manager 100 selects a device complying with the collection policy, the application does not need to specify a device in a context collection request. However, when the application explicitly specifies a device in the context collection request, the context manager 100 may of course determine whether the device is appropriate or not.

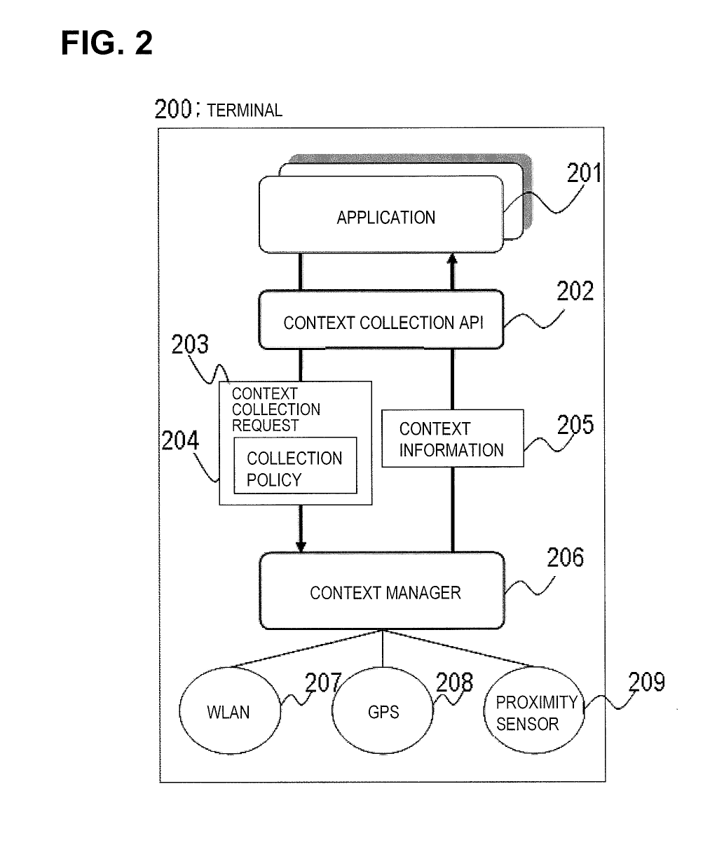

FIG. 2 illustrates a configuration of a terminal according to a first exemplary embodiment of the present invention. FIG. 2 illustrates a configuration of a terminal 200 acquiring location information as a context.

While not limited thereto, an application 201 is an application that operates by using context information collected by mapping software or the like.

A context collection API (Application Program Interface) 202 includes an interface for setting a collection policy in a context manager 206. The context collection API 202 sends a context collection request 203 (including a collection policy 204) to the context manager 206. The context collection API 202 receives context information 205 from the context manager 206 and supplies the context information 205 to the application 201.

The context manager 206 has a configuration similar to that of the module 100 illustrated in FIG. 1. Based on the collection policy sent via the context collection API 202, the context manager 206 determines an optimum context collection device.

Examples of such context collection device include a location information acquisition device, a temperature acquisition device, and a movement speed acquisition device. In the present exemplary embodiment, the description will be made based on a location information acquisition device.

FIG. 3 is a device catalog used when the context manager 206 of FIG. 2 determines a device to be used. In the terminal 200, this device catalog is stored in a storage area accessible by the context manager 206.

The device catalog, which is stored in the storage unit 105 in FIG. 1, includes attribute information and execution condition.

In the device catalog, the attribute information is compared with the collection policy sent from the application. Each device is associated with the attribute information including acquirable context information, a granularity, and a real-time property information about collection intervals. The granularity represents a level of detail of a context to be acquired.

The real-time property represents a time interval at which a context can be acquired. The real-time property is quantified; for example, value 1 represents a high real-time property and value 10 represents a low real-time property.

In the device catalog, the execution condition indicates conditions enabling an operation of a device, such as active condition (state in which a device can be acquired), a terminal additional impact (additional impact on the terminal by an operation of a device), and a current status representing whether a device is acquirable or not. The current status is updated periodically. In the terminal additional impact, power consumption having value 1 represents low power consumption and power consumption having value 10 represents high power consumption.

The device catalog table may be pre-installed in the terminal 200 of FIG. 2, or may be downloaded from a server (not illustrated).

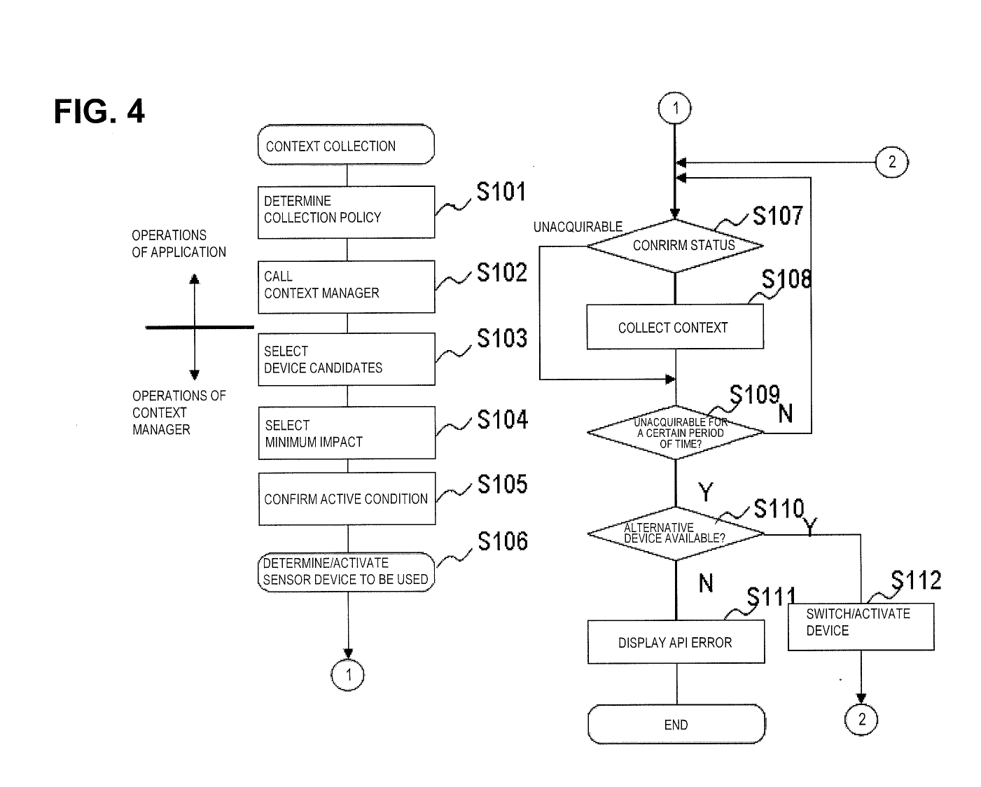

FIG. 4 is a flow chart illustrating an operation example of the terminal of FIG. 2.

The operation will be described based on a situation where the map application 201 operating on the mobile phone needs location information.

The application 201 determines a context collection policy (step S101) and sends a context collection request 203 including the collection policy 204 to the context manager 206 by using the context collection API 202. In practice, the application 201 calls the context manager 206 (module) by using the context collection request 203 as parameters (step S102). The collection policy 204 (parameters) includes context identification information, a granularity, and a real-time property.

The context identification information included in the collection policy 204 is an identifier representing a context. Examples of the context identification information include location information, the temperature, and a movement speed. The context identification information corresponds to any one of the context identification information in attribute of the device catalog.

In the collection policy 204, the representation format of the granularity differs depending on contents of a context. For example, in case the context includes location information, the granularity may be represented as follows: 2 km radius=5, 1 km radius=4, - - - , 100 m radius=2, and 10 m radius=1. The granularity corresponds to any one of the granularities in the device catalog.

In the collection policy 204, value 1 defines a high real-time property and value 10 defines a low real-time property. The real-time property included in the collection policy 204 corresponds to the real-time property in the device catalog.

In addition to the context collection request, the context collection API 202 is supplied with a context collection stop request and a context status request, for example.

The context manager 206 receives the context collection request via the context collection API 202 and selects device candidates (step S103). More specifically, based on the context identification information, the granularity, and the real-time property, the context manager 206 selects more appropriate device candidates from the device catalog.

For example, when the context manager 206 is called via the context collection API 202, if the parameters indicate “location information, granularity: 3, and a real-time property,” the context manager 206 refers to the device catalog of FIG. 3 and selects the following devices as candidates:

GPS (location information, 2, 5),
3G base station ID (location information, 4, 3), and
wireless LAN ESSID (location information, 3, 5).

Among these candidates, a device which places a minimum terminal additional impact is selected (step S104). The 3G base station ID has the minimum terminal additional impact. However, the attribute of the 3G base station ID does not satisfy granularity 3. Thus, the wireless LAN ESSID satisfying this condition is selected as a device.

When a device to be used is determined, the active condition of the device is confirmed (step S105), and subsequently, the device to be used (sensor device) is activated (step S106). After the device status is confirmed (step S107), an actual context is collected (step S108). Namely, before the device collects a context, the device status is confirmed (step S107), thereby realizing reliable context acquisition.

The status of each device is written by control software of the device at certain intervals in the “current status” of the device in the device catalog.

After the status is confirmed, if the device is unacquirable (unacquirable in step S107), re-acquisition is retried several times. If the device is unacquirable for a certain period of time (YES in step S109), an alternative device is selected.

If no alternative device is available (No in step S110), an application error is issued (step S111), and the processing ends.

If an alternative device is available (YES in step S110), the device is activated (step S112), the status identification of the device is performed (step S107), and the context collection is resumed (step S108). When the context information is sent to the application, the fact that the context information includes data from the alternative device is notified.

Next, effects and advantages of the present embodiment will be described.

Since the terminal includes a device catalog, it is possible to restrain unnecessary operation of a device provided in the terminal.

Since an application that will use a context sends a notification on the collection policy, more appropriate context information complying with conditions set by the application can be acquired.

Since an application that will use a context sends a notification on the collection policy, a plurality of devices may be used alternately.

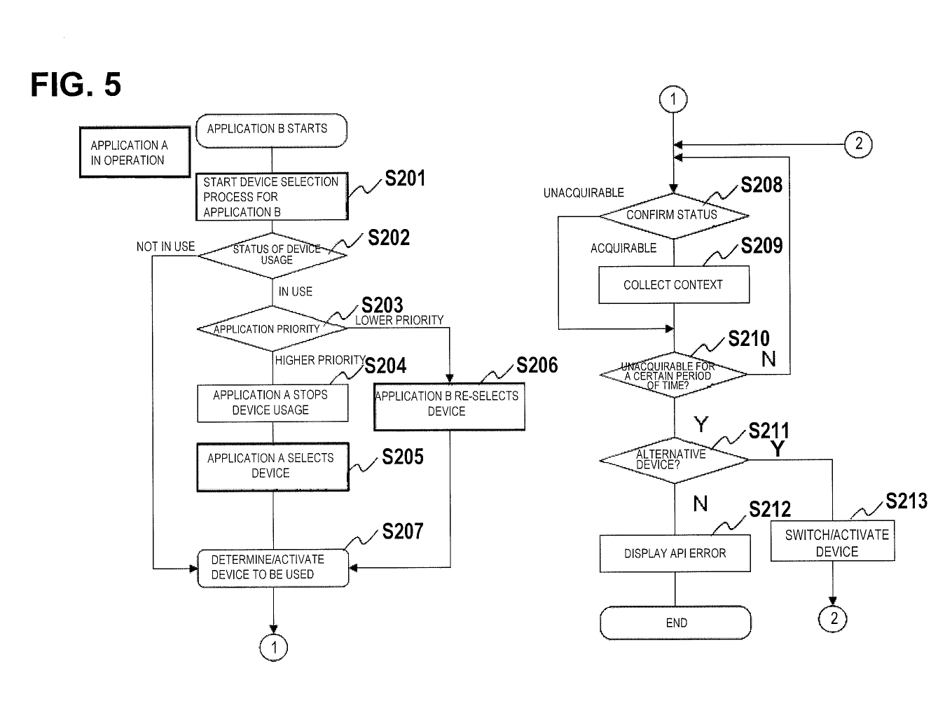

As a variation of the present exemplary embodiment, an operation of arbitration of a device conflict among a plurality of applications will be hereinafter described. FIG. 5 is a flow chart illustrating an operation of the present exemplary embodiment. The following description is based on a situation where an application A is currently using a device via the context manager 100 and is acquiring context information. In this situation, if an application B issues a new context collection request to the context manager 100 and the context manager 100 selects the device being used by the application A as a candidate for the application B (step S201), since the device is in use (in use in step S202), a device conflict occurs between the applications A and B. In order to resolve this conflict, the context manager 100 compares execution priorities described in the collection policies of the individual applications (step S203).

As a result of the comparison, if the execution priority of the application B is lower than the execution priority of the application A (lower priority in step S203), the context manager 100 selects a device for the application B which is different from the device being used by the application A (step S206). On the other hand, if the execution priority of the application B is higher than the execution priority of the application A (high priority in step S203), the context manager 100 suspends the device that is in use by the application A (step S204) and selects an alternative device for the application A (step S205). The context manager 100 determines and activates the device (step S207), and the application B starts to use the device that has been used by the application A.

The context manager 100 identifies the status of the device (step S208), and if the context information is acquirable from the device, the context information is collected (step S209), the context information is supplied to the application that has requested for the context information, and the context information collection is repeated (NO in step S210). In case the result of the identification of the device status indicates that the context information is unacquirable (unacquirable in step S208) or after the context information collection (step S209), if the acquisition of the context information from the device is not possible for a predetermined period of time (YES in step S210), the context manager 100 refers to the device catalog and determines if an alternative device is available. If no alternative device is available (NO in step S211), an API error is displayed (step S212). If an alternative device is available (YES in step S211), the context manager 100 selects and activates the alternative device (step S213).

Other than the application execution priority, as an evaluation index, a collection policy sent from an application may include information such as a real-time property. If a plurality of applications has an identical collection policy including a real-time property and the like, the context manager 100 may allow the plurality of applications to share the same device simultaneously. For example, even when the application A has a higher execution priority, if the applications A and B have an equal real-time property, the applications A and B may use an identical device simultaneously.

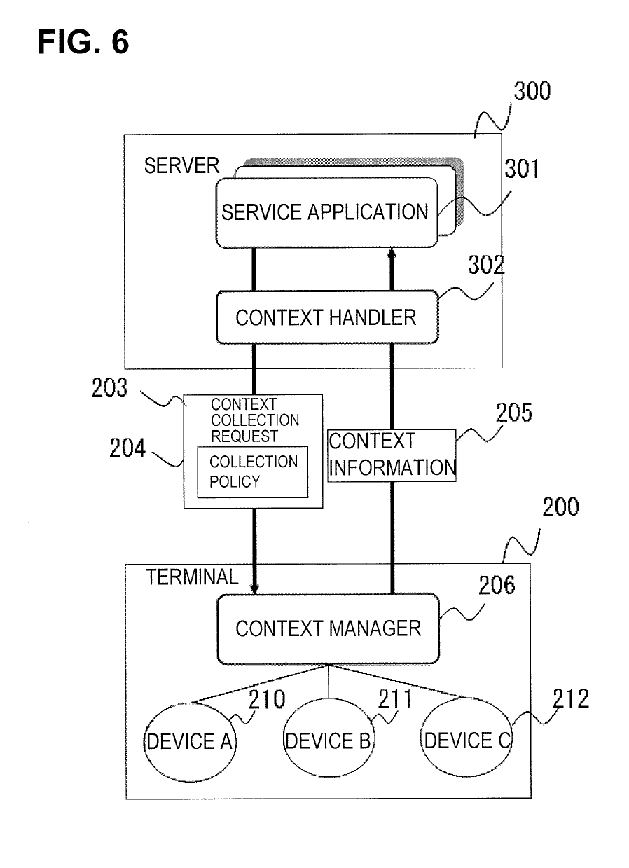

Next, a second exemplary embodiment of the present invention will be described. FIG. 6 is a configuration according to the second exemplary embodiment of the present invention. While the present exemplary embodiment is basically the same as the first exemplary embodiment, in the present exemplary embodiment, the application is not operated on the terminal but on a server connected through a network.

A server on which a service application is executed includes a context handler for communicating with a context manager on a terminal.

A context handler 302 and the context manager 206 use a communication protocol such as http (hyper text transport protocol) to exchange messages such as context collection requests or actual context information. The context handler 302 is not only capable of communicating with the context manager of a single terminal but context managers of a plurality of terminals. A server 300 sends the context collection request 203 (including the collection policy 204) to the context manager 206 of the terminal 200, and the context manager 206 sends the context information 205 to the server 300.

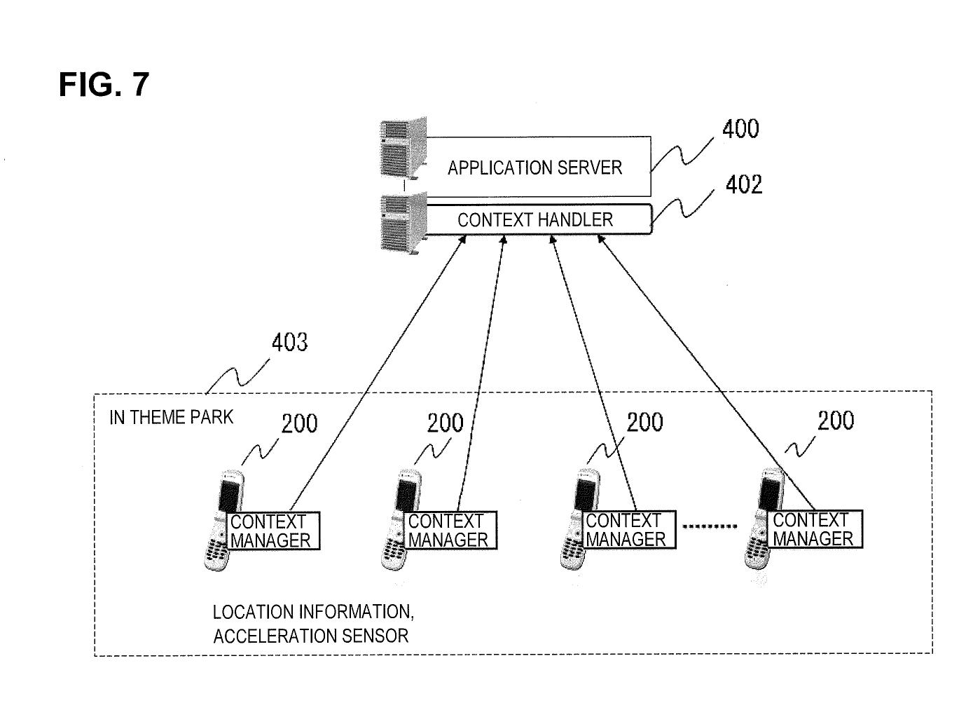

By using the server system shown in FIG. 6, for example, a service as illustrated in FIG. 7 can be provided.

The service enables assessment of congestion at an attraction or the like at a crowded place such as a theme park 403.

An application server 400 collects location information or context information of acceleration sensors from a plurality of terminals 200 in the theme park 403. The application server 400 carries out mapping to determine the direction of the flow of people and the density of people.

For example, the system according to the present invention is suitably applicable to a navigation system and the like. In this case, the application acquires location information from a device and displays an area map including the location information (context information) on an appropriate scale. For example, a device can be selected and a map information scale (granularity) can be changed depending on the terminal movement speed. More specifically, for example, when the terminal is moving at high speed, location information is acquired from a base station ID in a serving cell, and a large area display is made. On the other hand, when the terminal is moving at low speed, location information is acquired from a GPS, and a narrow area display is made. The present invention is also applicable to a system configuration including a terminal equipped with a device such as an atmospheric pressure sensor. Based on such system configuration, an application executable on the terminal transfers atmospheric pressure information via a base station to a host apparatus of the base station, and the host apparatus conducts weather forecast. In this way, local weather forecast can be conducted, and the terminal can download the local weather forecast.

Modifications and adjustments of the exemplary embodiments and examples are possible within the scope of the overall disclosure (including claims) of the present invention and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

1. An information processing system comprising:
at least one application that acquires context information from a device and executes a predetermined function;
a storage unit that stores attribute information and execution condition of a device as a device catalog; and
a management unit that responsive to a request from the application, selects a device which the application uses; wherein
in collecting context information, the application sends a collection policy of the context information to the management unit, and
the management unit, upon receiving the collection policy from the application, refers to the collection policy and the attribute information and execution condition of a device stored as the device catalog in the storage unit to select a device complying with the collection policy.

2. The information processing system according to claim 1, wherein, when receiving a context collection request from the application, the management unit receives context information collected by the device selected as complying with the collection policy and supplies the context information to the application.

3. The information processing system according to claim 1, wherein the management unit comprises:
a context attribute confirmation unit that analyses contents of attribute information of a context based on a collection policy requested from the application;
an active condition confirmation unit that refers to the device catalog and selects one or more device candidates complying with the attribute information confirmed by the context attribute confirmation unit;
a terminal impact evaluation unit that refers to the device catalog and evaluates a device candidate which gives a minimum terminal impact from among the device candidates selected by the active condition confirmation unit; and
a context collection method determination unit that determines a device necessary for collecting a context, based on a device condition of the candidate selected by the terminal impact evaluation unit.

4. The information processing system according to claim 1, further comprising
a context collection unit that controls a device based on the device and determined by the context collection method determination unit of the management unit.

5. The information processing system according to claim 1, wherein the device catalog comprises, for each device,
attribute information including context identification information, a granularity, and a real-time property; and
execution condition including an active condition, an impact to a terminal in case of adding a device to the terminal, and a current status.

6. The information processing system according to claim 1, wherein, in collecting the context information, the application sends a context collection request including the collection policy to the management unit and
the management unit selects a device complying with the collection policy so that there is no need for the application to specify any device.

7. The information processing system according to claim 1, wherein, in case, when an application is acquiring context information from a device, the management unit receives a context information collection request from another application and a conflict for the device occurs between the applications, the management unit performs arbitration of the conflict for the device between the applications in accordance with priorities of the applications to allow one of the applications having a relatively higher priority to collect context information from the device.

8. The information processing system according to claim 7, wherein the management unit performs reselection of a device for an application having a relatively lower priority.

9. The terminal comprising
the information processing system according to claim 1.

10. The terminal according to claim 9, wherein the application is operated on the terminal.

11. The system comprising
a server connected to the terminal according to claim 9, wherein the application is operated on the server.

12. A context utilization method comprising:
storing and managing, on a manager side, as a device catalog, attribute information and execution condition of a device from which an application acquires context information to execute a predetermined function and that selects a device which the application uses responsive to a request from the application;
in collecting context information, the application sending a collection policy of the context information to the manager; and
the manager selecting a device complying with the collection policy, based on the collection policy from the application and the attribute information and execution condition of a device stored in the device catalog.

13. The context utilization method according to claim 12, comprising
upon receiving a context collection request from the application, the manager providing the application with context information collected by a device which is selected as complying with the collection policy.

14. (canceled)

15. (canceled)

16. (canceled)

17. A terminal comprising:
a plurality of devices;
a management unit that stores and manages attribute information and execution condition of the plurality of devices as a device catalog;
wherein, when an application that operates on the terminal or on a server connected to the terminal collects context information from the device, the application sends a collection policy of the context information to the management unit,
the management unit selects a device that complies with the collection policy based on the collection policy requested from the application and the attribute information and execution condition of devices stored in the device catalog, and
the application acquires context information from the device selected by the management unit and a executes predetermined function.

18. The terminal according to claim 17, wherein the management unit further comprises:
a context attribute confirmation unit that analyzes contents of based on a collection policy requested from the application;
an active condition confirmation unit that refers to the device catalog and selects one or more device candidates complying with the attribute information confirmed by the context attribute confirmation unit;
a terminal impact evaluation unit that refers to the device catalog and evaluates a device candidate which gives a minimum terminal impact from among the candidates selected by the active condition confirmation unit; and
a context collection method determination unit that determines a device necessary for collecting a context based on a condition of the candidate selected by the terminal impact evaluation unit.

19. The terminal according to claim 17, wherein the device catalog comprises, for each device,
attribute information including context identification information, a granularity, and a real-time property; and
execution condition including an active condition, an impact to a terminal in case of adding a device to the terminal, and a current status.

20. (canceled)
